(19) United States
(12) Patent Application Publication
(10) Pub. No.: US 2009/0315238 A1
(43) Pub. Date: Dec. 24, 2009

(54) Modular Adjustable Vise

(75) Inventors: Robert Schroeder, Machesney Park, IL (US); Donald F. McKibben, Machesney Park, IL (US)

Correspondence Address: REINHART BOERNER VAN DEUREN P.C., 2215 PERRYGREEN WAY, ROCKFORD, IL, 61107, US

(73) Assignee: Pacific Bearing Company, Rockford, IL (US)

(21) Appl. No.: 12/487,221

(22) Filed: Jun. 18, 2009

Related U.S. Application Data
(60) Provisional application No. 61/074,075, filed on Jun. 19, 2008.

(51) Int. Cl. B25B 1/02

(52) U.S. Cl. 269/142

(57) ABSTRACT

A modular adjustable vise is provided. The modular adjustable vise includes a base and a plurality of vise units mounted to the base. The plurality of vise units are spaced apart. Each vise unit includes a pair of jaws movable toward and away from one another to form an adjustable gap therebetween. Each of the vise units are independently adjustable such that the adjustable gap of each vise unit can be adjusted independent of the gap of the other vise units. A method for configuring a vise is also provided that includes machining a clamping surface of a jaw of the vise unit after the jaw has been mounted to the base.

### CROSS-REFERENCE TO RELATED PATENT APPLICATIONS

This patent application claims the benefit of U.S. Provisional Patent Application No. 61/074,075, filed Jun. 19, 2008, the disclosure and teachings of which are incorporated herein, in their entireties, by reference.

### FIELD OF THE INVENTION

This invention generally relates to mechanisms for holding material and more particularly to vises.

### BACKGROUND OF THE INVENTION

Vises are used to securely hold material as it is being machined or otherwise worked on. A vise will include a pair of jaws that move relative to one another to clamp the material therebetween to prevent the material from moving during the machining process or work process. The present invention relates to improvements over the current state of the vise and clamping art.

### BRIEF SUMMARY OF THE INVENTION

In one aspect, the invention provides a modular adjustable vise that can be used to clamp and hold material. The modular adjustable vise can be used to clamp or grasp irregularly shaped devices. In practicing an embodiment of the invention, the modular adjustable vise includes a base and a plurality of vise units mounted to the base. The plurality of vise units are spaced apart. Each vise unit includes a pair of jaws movable toward and away from one another to form an adjustable gap therebetween. Each of the vise units are independently adjustable such that the adjustable gap of each vise unit can be adjusted independent of the gap of the other vise units.

In another aspect, the invention provides a method for configuring a modular adjustable vise that includes machining a clamping surface of a jaw of the vise unit after the jaw has been mounted to the base. This method is particularly useful for improved accuracy in aligning a plurality of clamping surfaces for independent vise units. Further, the method can be used to resurface a clamping surface after the surface has been worn due to use.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top perspective illustration of a first embodiment of a modular adjustable vise according to the teachings of the present invention;

FIG. 2 is an end profile illustration of the modular adjustable vise of FIG. 1;

FIG. 3 is a top plan illustration of the modular adjustable vise of FIG. 1;

FIG. 4 is a side profile illustration of the modular adjustable vise of FIG. 1;

FIG. 5 is a top plan illustration of a modular adjustable vise according to another embodiment of the invention; and

FIG. 6 is a top plan illustration of a modular adjustable vise according to another embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

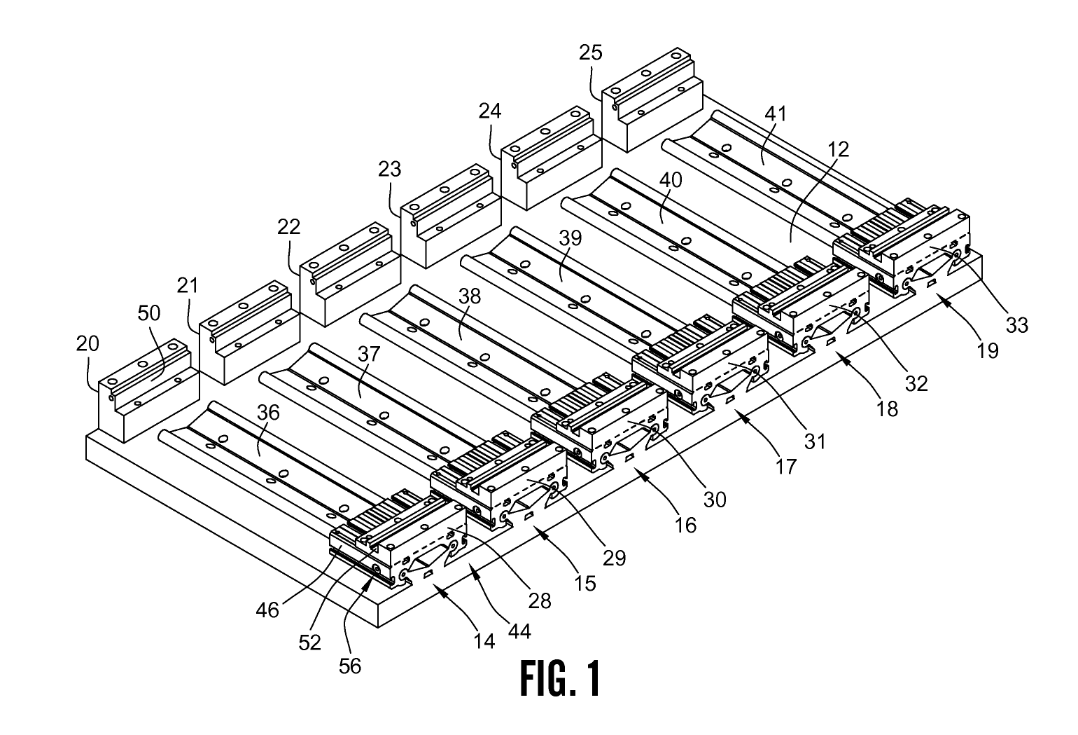

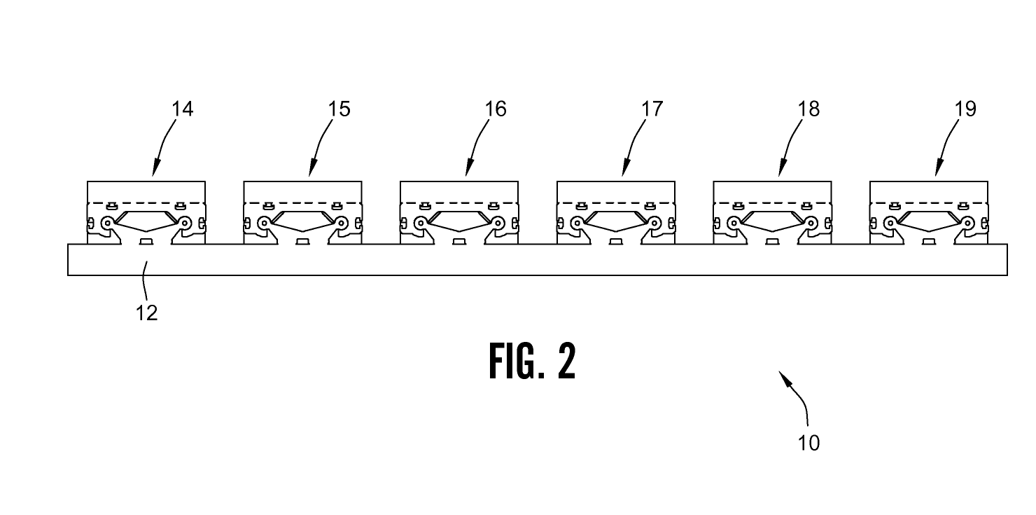

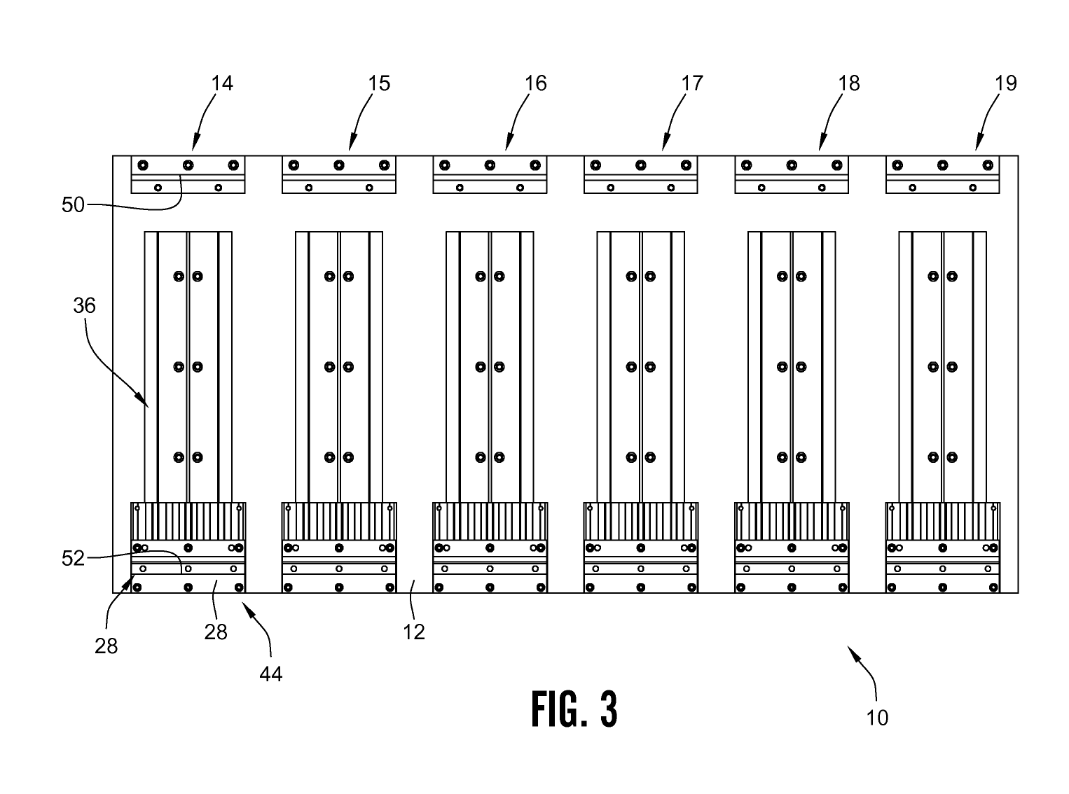

FIGS. 1-4 illustrate an exemplary embodiment of a modular adjustable vise 10 according to the teachings of the present invention. The vise 10 is an infinitely-adjustable clamping mechanism that can be used to secure objects in a multitude of applications including, but not limited to, machine fixtures, assembly fixtures and maintenance applications. Not only can the vise 10 be used for a multiple of applications, the vise 10 can be used to hold varying sized and shaped products due to the adjustability of the vise 10 as will be more fully described below.

The vise 10 generally includes a base 12 to which a plurality of vise units 14-19 are mounted. In the illustrated embodiment, the vise 10 includes six (6) laterally spaced apart vise units 14-19. However, other vises according to the teachings of the present invention can include more or less vise units. The vise units 14-19 are independently adjustable. Therefore, one of the vise units, such as vise unit 14, can be adjusted without affecting the configuration of another one of the vise units such as vise unit 15. This configuration of a plurality of vise units 14-19 allows the configuration of the vise 10 to be substantially varied to accommodate different work pieces, as well as work pieces having non-uniform/symmetric shapes.

The features of the individual vise units 14-19 will now be described in more detail with primary reference to vise unit 14. Vise unit 14 includes a fixed jaw portion 20, a moveable jaw portion 28 and a guide rail 36. The moveable jaw portion 28 forms part of a carriage assembly 44 that moves linearly along guide rail 36. The carriage assembly further includes a carriage body 46 to which the moveable jaw portion 28 is removably mounted. However, in other embodiments, the movable jaw portion 28 could be formed as a single piece with the carriage body 46.

In a preferred embodiment, the carriage body 46 is mounted to the guide rail 36 by using a reduced-friction arrangement. For example, the reduced-friction arrangement could include a plurality of Teflon inserts. Further, the guide rail is preferably formed from a stainless material such as stainless steel or aluminum so as to prevent any formation of rust or other defects on the guide rail. Further, the guide rail could be precision-machined and hard-lubed anodized to reduce friction. By using a hard-lubed anodized guide rail 36 and a Teflon insert within the carriage body 46, the carriage assembly 44 can slide along the linear guide rail without the need for any lubrication. By eliminating the need for lubrication, any chips or debris formed during a machining process can easily be removed or cleared from the vise 10, and particularly from the guide rail.

However, alternative means for mounting the carriage body 46 to the guide rail 36 could be employed. For example, the carriage body could include a set of guide rollers that ride on the guide rail 36.

In a preferred embodiment, the carriage assembly 44 is manually positioned relative to the fixed jaw 20. However, alternative embodiments could incorporate automatic adjustment of the position of the carriage assembly 44 relative to the fixed jaw 20. More particularly, a lead screw or servo-mechanism could be coupled to the carriage body to drive the carriage assembly 44 along the guide rail 36.

The fixed jaw 20 and moveable jaw 28 are preferably removable and replaceable. As such, when the jaws 20, 28 become worn, they can be replaced. In a preferred embodiment, the jaws include replaceable or removable jaw pads 50, 52. The removable or replaceable pads 50, 52 provide flexibility in that the jaws can be easily configured to clamp the type of material that is being secured with the vise. For example, if the appearance of the material held by vise 10 is important, pads 50, 52 could include a smooth surface so as to prevent marring of the surface of the material held by vise 10. Alternatively, if it is important to have a good bite between the jaws 20, 28 and the clamped material, the pads 50, 52 could include serrations on their face so as to increase the engagement between the jaws 20, 28 and the clamped material.

In one method for assembling and configuring the vise 10, the user will first assemble the vise component of the jaws 20, 28 and all adjacent vise component jaws, carriage body 46 and all adjacent carriage bodies, and guide rail 36 and all adjacent guide rails. Once the vise 10 is assembled, the user can then machine the pads 50 and all adjacent pads mounted to the fixed jaw 20 and all adjacent fixed jaws respectively in one pass so to have increased tolerances that are eliminated due to the independent assembly of the vise units 14-19. More particularly, by machining the face of the pads 50 and all adjacent pads after assembly, the user can guarantee that the faces of the pads 50 and adjacent pads are generally parallel to one another and therefore remove any misalignment due to tolerances in mounting the vise units 14-19 to base 12. This same process may then be repeated for pad 52 and all adjacent pads, and achieve the same parallelism and tolerancing.

In the illustrated embodiment, the fixed jaws 22-25 are directly mounted to base 12. However, in alternative embodiments, the fixed jaws 22-25 can be directly and/or permanently affixed to the guide rails 36-41.

In the illustrated embodiment, the moveable jaw portions 28-33 are separate and removable components from the carriage body of the individual vise units 14-19. However, in other embodiments, the carriage body and moveable jaw portions 28-33 can be formed into one-piece components. One piece shall mean formed from a single piece of material and not an assembly of parts.

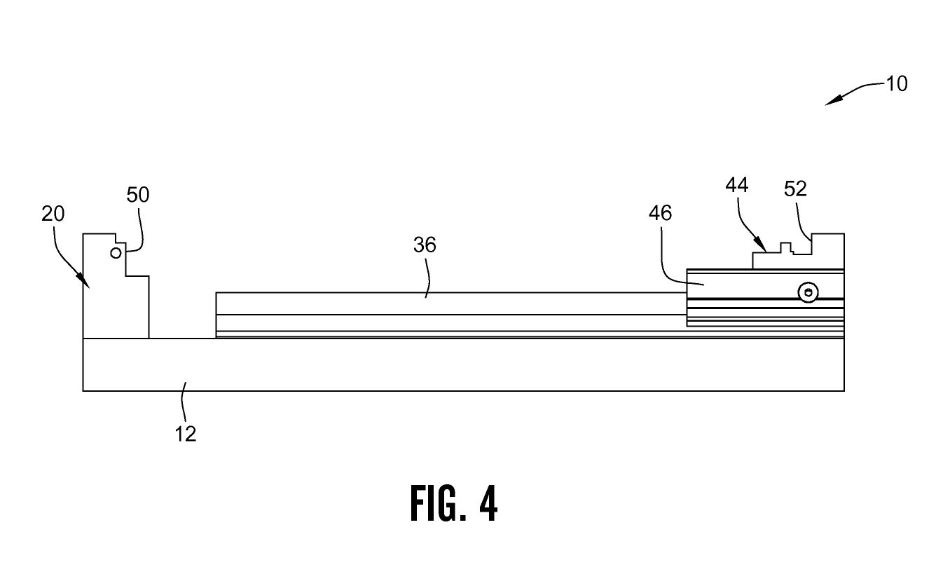

Returning to vise unit 14, carriage body 46 includes an integrated lock arrangement 56. The integrated lock arrangement 56 acts to lock the position of the moveable jaw portion, and particularly carriage body 46, relative to the fixed jaw 22. As such, the integrated lock arrangement 56 maintains the clamping force on any material that is being held by the vise unit 14. In one implementation, the integrated lock arrangement is a hand brake that incorporates a handle (shown in FIG. 4) external to the carriage body that can be easily manipulated by the operator. The hand brake can include a Teflon pad that engages the guide rail 36 to increase friction therebetween and prevent movement of the carriage assembly 44 along the guide rail 36. Alternative integrated lock arrangements can incorporate wedges or other mechanisms to provide a lock for the carriage body 46. Further yet, a positive stop arrangement can be added to prevent movement of the carriage body 46. Further, an independent lock arrangement that is not integrated into the carriage body can be used. Typically, the independent lock arrangement would be positioned behind the carriage body and it would engage the guide rail. Alternatively, it could engage the base 12. As such, the carriage body and therefore carriage assembly 44 would be positioned axially between the fixed jaw 22 and the independent lock arrangement.

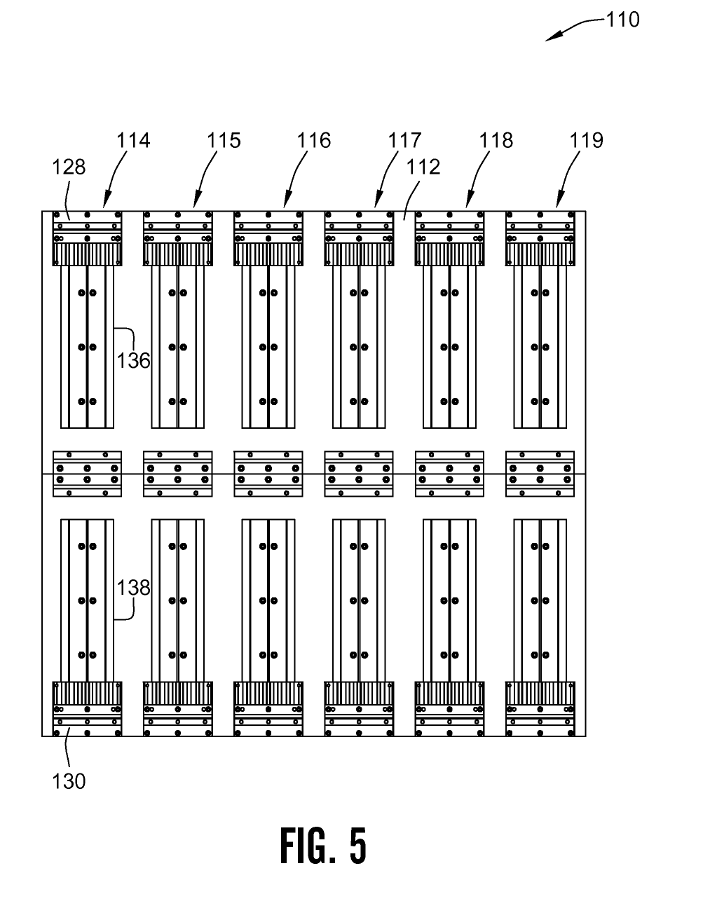

FIG. 5 illustrates an alternative embodiment of a modular adjustable vise 110 according to the teachings of the present invention. The vise 110 is similar to the vise 10 of the previous embodiment. The features that are different for this embodiment will now be described.

Vice 110 includes a base 112 and a plurality of vise units such as unit 114. vise unit 114 includes a fixed jaw 122 interposed between a pair of moveable jaws 128, 130. The moveable jaws 128, 130 are mounted to guide rails 136, 138 for linear movement toward and away from fixed jaw 122.

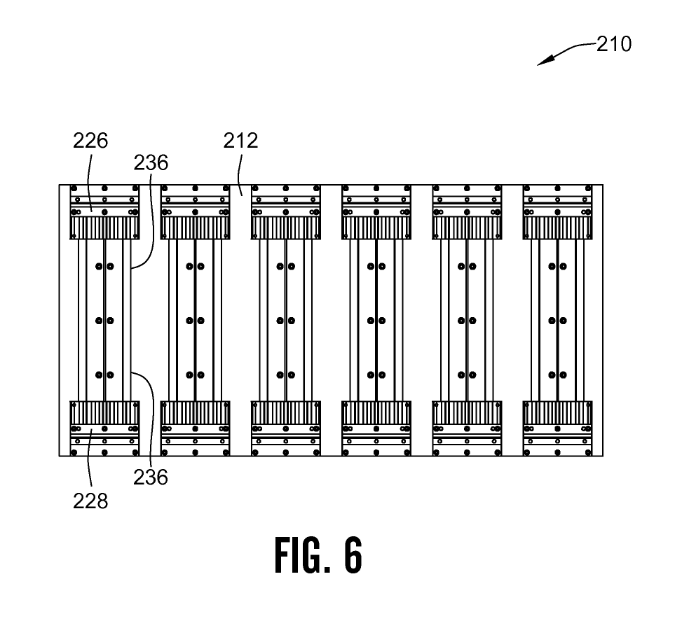

A further embodiment of a modular adjustable vise 210 is illustrated in FIG. 6. vise 210 is similar to the previous embodiments. However, vise 210 does not include any fixed jaws. More particularly, both jaws 226, 228 are moveable relative to guide rail 236. As such, either one or both of the jaws 226, 228 can be moved to clamp a device. This arrangement is very conducive to clamping irregular-shaped materials. For a simple example, a T-shaped device could be clamped such that a narrow portion or stem portion of the T is clamped by a plurality of the vise units 214 while the head or transverse portion of the T-shaped material could be clamped by a different one of the vise units. More particularly, the moveable jaw portions 226, 228 of the vise units 214 that would be positioned proximate the stem portion of the T would be moved very close together while the moveable jaw portions 226, 228 would be positioned farther apart to accommodate the larger width of the head portion of the T-shaped material.

In this arrangement, all of the moveable jaw portions 226, 228 could be configured like the moveable jaw portions described previously. As such, these jaw portions 226, 228 could include Teflon guide surfaces or guide rollers for providing limited friction movement along guide rails 236. Further, the moveable jaw portions 226, 228 could be manually positioned relative to one another or alternatively driven together independently or simultaneously automatically by lead or ball screws or cylinders or other types of linear actuating mechanisms. Again, the moveable jaw portions 226, 228 could include removable or replaceable jaw or clamp pads to further adapt the vise 210 to the material being secured by the vise 210. Additionally, the removable or replaceable pads permit machining of the moveable jaw portions 226, 228 to maintain tolerances. Further, once the pads are worn out, they can be replaced so that the entire vise 10 need not be disposed of.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context

What is claimed is:

1. A modular adjustable vise comprising:
a base;
a plurality of vise units mounted to the base and laterally spaced apart, each vise unit including a pair of jaws movable toward and away from one another to form an adjustable gap therebetween; and
wherein each of the vise units are independently adjustable such that the adjustable gap of each vise unit can be adjusted independent of the gap of the other vise units.

2. The modular adjustable vise of claim 1, wherein each pair of jaws for each vise unit includes a fixed position jaw that has a fixed position relative to the base and a first movable jaw that is linearly movable toward and away from the fixed position jaw.

3. The modular adjustable vise of claim 2, wherein each vise unit further includes a second movable jaw that is linearly movable toward and away from the fixed position jaw, the fixed position jaw being interposed between the first and second movable jaws.

4. The modular adjustable vise of claim 2, wherein each fixed position jaw includes a clamping surface, all of the clamping surfaces of the fixed position jaws being axially aligned and generally co-planar.

5. The modular adjustable vise of claim 2, wherein each vise unit includes a linear guide rail, the first movable jaw being mounted to the linear guide rail for movement toward and away from the fixed position jaw.

6. The modular adjustable vise of claim 5, wherein each vise unit further includes a break for locking the position of the first movable jaw relative to the fixed position jaw.

7. The modular adjustable vise of claim 6, wherein the break is an integrated break assembly including a hand brake having a handle, the hand brake operably engaging the guide rail.

8. The modular adjustable vise of claim 6, wherein the brake is a brake assembly that is separate and independent from the first movable jaw.

9. The modular adjustable vise of claim 2, wherein the first movable jaw is an assembly that includes a carriage and a jaw portion fixedly attached to the carriage, each vise unit including a linear guide rail upon which the carriage is mounted for linear movement there along.

10. The modular adjustable vise of claim 9, wherein each carriage includes at least one Teflon bearing interposed between a carriage body and the guide rail. the Teflon bearing being in a fixed position relative to the carriage body when the carriage is mounted to the guide rail and the Teflon bearing movable relative to the guide rail.

11. The modular adjustable vise of claim 2, wherein fixed position jaw and the first movable jaw each include a support body and a clamping pad, the clamping pad being removably mounted to the support body.

12. The modular adjustable vise of claim 1, wherein each vise unit includes a first movable jaw and a second movable jaw that is linearly movable toward and away from the second movable jaw, the first and second movable jaws mounted to a linear guide rail for movement there about.

13. The modular adjustable vise of claim 6, wherein:
each fixed position jaw includes a clamping surface, all of the clamping surfaces of the fixed position jaws being axially aligned and generally co-planar;
the first movable jaw is an assembly that includes a carriage and a jaw portion fixedly attached to the carriage, each vise unit including a linear guide rail upon which the carriage is mounted for linear movement there along;
each carriage includes at least one Teflon bearing interposed between a carriage body and the guide rail. the Teflon bearing being in a fixed position relative to the carriage body when the carriage is mounted to the guide rail and the Teflon bearing movable relative to the guide rail; and
fixed position jaw and the first movable jaw each include a support body and a clamping pad, the clamping pad being removably mounted to the support body;
each vise unit further includes a second movable jaw that is linearly movable toward and away from the fixed position jaw, the fixed position jaw being interposed between the first and second movable jaws; and
each fixed position jaw including clamping surfaces on opposed sides such that one clamping surfaces faces and is aligned with one of the movable jaws and the other one of the clamping surfaces faces and is aligned with the other one of the movable jaws.

14. A method of configuring a vise comprising the steps of:
mounting at least one clamping pad to a base; and
machining a clamping surface of the at least one clamping pad after the clamping pad has been mounted to the base.

15. The method of configuring a vise of claim 14 wherein the at least one clamp includes a plurality of adjacent clamping pads and the step of machining includes machining the clamping surfaces of the plurality of adjacent clamping pads sequentially in a single pass such that all clamping surfaces are substantially co-planar.

16. The method of configuring a vise of claim 14, further including the step of:
replacing the clamping pad with a second clamping pad.

17. The method of configuring a vise of claim 15, wherein the second clamping pad has a different characteristic than the original clamping pad.
